(19) United States
(12) Patent Application Publication
(10) Pub. No.: US 2012/0057383 A1
(43) Pub. Date: Mar. 8, 2012

(54) Standalone and Grid-Tie Power inverter

(75) Inventors: Jung-Tzung Wei, Taoyuan County (TW); Chung-You Lin, Taoyuan County (TW); Chih-Ying Lin, Taoyuan County (TW); Kuo-Kuang Jen, Taoyuan County (TW); Yu-Min Liao, Taoyuan County (TW)

(73) Assignee: Chung-Sham Institute of Science and Technology, Armaments, Bureau, Ministry of National Defense, Taoyuan County (TW)

(21) Appl. No.: 12/968,172

(22) Filed: Dec. 14, 2010

(30) Foreign Application Priority Data
Sep. 3, 2010 (TW) 099129896

(51) Int. Cl. H02M 7/44

(52) U.S. Cl. 363/98

(57) ABSTRACT

A standalone and grid-tie power inverter includes a DC-to-AC converter, an output circuit electrically connected to the DC-to-AC converter, and a control unit electrically connected to the DC-to-AC converter and the output circuit. The DC-to-AC converter converts a DC power source into an AC power output. The output circuit includes a grid-tie switch for connecting the AC power output to a grid or isolating the AC power output from the grid. The control unit instructs the DC-to-AC converter to provide the AC power output based on a command signal and a feedback signal from the DC-to-AC converter. The control unit controls the grid-tie switch to switch the standalone and grid-tie power inverter between a standalone mode and a grid-tie mode.

### BACKGROUND OF INVENTION

1. Field of Invention

The present invention relates to an power inverter and, more particularly, to a standalone and grid-tie power inverter.

2. Related Prior Art

As the science develops, our demand for power gets higher and higher. Hence, the practicality and stability of power inverters are important.

Regarding the control over signals, various changes in parameters of the conventional power inverters and uncertainties are often encountered in the use of the conventional power inverters. In the field of control, there are various theories such as proportional integral derivative (“PID”) control, computed torque control and sliding-mode control, a form of variable structure control. These theories are developed to cause systems to operate as expected by their designers regardless of the various changes in the parameters of the system and various external interferences.

PID controllers involve simple structures and can easily be designed at low costs. Hence, PID controllers are commonly used in the industry. PID controllers however do not provide satisfactory performance for systems with uncertain dynamics.

In the computed torque control, some or all of the non-linear items are deleted from a non-linear equation, thus providing a linear equation, and a linear feedback controller is designed to achieve closed-loop control characteristics as designed. However, the computed torque control is based on the ideal deletion of the non-linear dynamics and lacks understanding of uncertainties in the system in the time domain such as the changes in the parameters of the system and the external interferences. Hence, a large control gain is often chosen to achieve robustness of the system and ensure stability of the system.

The sliding-mode control is effective non-linear robustness control. In a sliding mode, the controlled system is not affected by the uncertainties and the interferences. A sliding surface causes the controlled system to provide two substructures or more. Then, switch conditions are used to provide another sliding mode. Therefore, the sliding-mode control provides excellent dynamic response.

A sliding-mode control system is designed in two steps. At first, a sliding surface is chosen in a state change space according to required closed-loop control. Secondly, a control algorithm is designed to cause the state of the system to move to the sliding surface and then remain on the sliding surface. In the beginning, the state of the system moves to the sliding surface, and this process is called the “reaching phase.” Once reaching the sliding surface, the state of the system remains on the sliding surface and moves to a target, and this process is called the “sliding phase.” However, in the reaching phase, the system is still affected by the changes in the parameters of the system and the external interferences, and the control performance of the system is affected by the uncertainties of the system.

Therefore, total sliding-mode control is advocated. That is, there is not any reaching phase, and all of the states remain on the sliding surface. Throughout the control cycle, the system is not affected by the uncertainties of the system. There are however risks of control vibration and unstable dynamics of the system.

To eliminate the control vibration, many scholars have introduced boundary layers. However, the system will be unstable if an improper width of the boundary layer is chosen. That is, there is no guarantee for stability in the boundary layers.

The present invention is therefore intended to obviate or at least alleviate the problems encountered in prior art.

### SUMMARY OF INVENTION

It is the primary objective of the present invention to provide a standalone and grid-tie power inverter.

To achieve the foregoing objective, the standalone and grid-tie power inverter includes a DC-to-AC converter, an output circuit electrically connected to the DC-to-AC converter, and a control unit electrically connected to the DC-to-AC converter and the output circuit. The DC-to-AC converter converts a DC power source into an AC power output. The output circuit includes a grid-tie switch for connecting the AC power output to a grid or isolating the AC power output from the grid. The control unit instructs the DC-to-AC converter to provide the AC power output based on a command signal and a feedback signal from the DC-to-AC converter. The control unit controls the grid-tie switch to switch the standalone and grid-tie power inverter between a standalone mode and a grid-tie mode.

In another aspect, the DC-to-AC converter includes a plurality of power switches and a low-pass filter. The power switches are electrically connected to one another in a full bridge manner. The low-pass filter is electrically connected to the power switches and the output circuit.

In another aspect, the AC power output includes an alternate output voltage and an alternate output current. The alternate output voltage is provided to an AC load when the grid-tie switch is turned off. The alternate output voltage is provided to the grid when the grid-tie switch is turned on.

In another aspect, the command signal is a current command signal or a voltage command signal. The feedback signal is a current feedback signal or a voltage feedback signal. The current feedback signal is the alternate output current, and the voltage feedback signal is the alternate output voltage.

In another aspect, the control unit includes a current controller, a voltage controller and a drive circuit. The first switch is realized by hardware or software. The drive circuit is electrically connected to the current controller or the voltage controller through the switching by the first switch.

In another aspect, based on the current command signal and the current feedback signal, the current controller controls the drive circuit to provide a plurality of drive signals to the power switches. The current controller further controls the duty cycles of the power switches to instruct the DC-to-AC converter to connect the alternate output current to the grid or isolate the alternate output current from the grid.

Alternatively, based on the voltage command signal and the voltage feedback signal, the current controller controls the drive circuit to provide a plurality of drive signals to the power switches. The current controller further controls the duty cycles of the power switches to instruct the DC-to-AC converter to connect the alternate output voltage to the grid or isolate the alternate output voltage from the grid.

In another aspect, the control unit adopts an adaptive total sliding-mode control method to control the duty cycles of the power switches to instruct the AC power output to follow command signal. The adaptive total sliding-mode control method includes a system performance-planning algorithm, a curbing controller algorithm and an adaptive algorithm. The system performance-planning algorithm is used to plan the performance of the DC-to-AC converter in a normal situation. The curbing controller algorithm is used to eliminate changes in parameters of the DC-to-AC converter and external load interferences to retain the operation of the DC-to-AC converter on a sliding surface. The adaptive algorithm is used to estimate a boundary value of a total uncertainty to spontaneously adjust the boundary value of the total uncertainty.

In another aspect, the total sliding-mode control method proves stability of the DC-to-AC converter through a Lyapunov function and Barbalet's lemma.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of a standalone and grid-tie power inverter according to the preferred embodiment of the present invention;

FIG. 2 is a diagram of an equivalent circuit of the standalone and grid-tie power inverter shown in FIG. 1 in a standalone mode;

FIG. 3 is a diagram of an equivalent circuit of a DC-to-AC converter of the standalone and grid-tie power inverter shown in FIG. 2 in a first mode;

FIG. 4 is a diagram of an equivalent circuit of the DC-to-AC converter of the standalone and grid-tie power inverter shown in FIG. 2 in a second mode;

FIG. 5 is a block diagram of an equivalent model of the DC-to-AC converter shown in FIG. 2;

FIG. 6 is a block diagram of a control unit and the DC-to-AC converter shown in FIG. 2 in total sliding-mode control;

FIG. 7 is a block diagram of the control unit and the DC-to-AC converter shown in FIG. 2 in adaptive total sliding-mode control;

FIG. 8 is a diagram of an equivalent circuit of the standalone and grid-tie power inverter shown in FIG. 1 in a grid-tie mode;

FIG. 9 is a diagram of an equivalent circuit of a DC-to-AC converter of the standalone and grid-tie power inverter shown in FIG. 8 in a first mode;

FIG. 10 is a diagram of an equivalent circuit of the DC-to-AC converter of the standalone and grid-tie power inverter shown in FIG. 8 in a second mode;

FIG. 11 is a block diagram of an equivalent model of the DC-to-AC converter shown in FIG. 8;

FIG. 12 is a block diagram of a control unit and the DC-to-AC converter shown in FIG. 8 in total sliding-mode control; and

FIG. 13 is a block diagram of the control unit and the DC-to-AC converter shown in FIG. 8 in adaptive total sliding-mode control.

### DETAILED DESCRIPTION OF PREFERRED EMBODIMENT

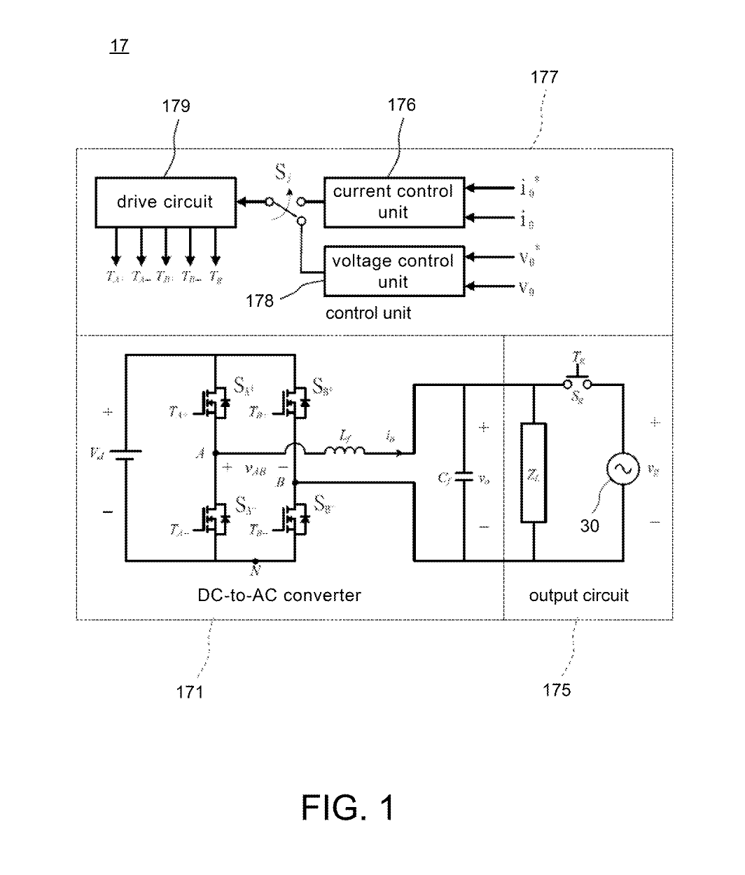

FIG. 1 shows a standalone and grid-tie power inverter 17 according to the preferred embodiment of the present invention. Referring to FIG. 1, the standalone and grid-tie power inverter 17 includes a DC-to-AC converter 171, an output circuit 175 and a control unit 177. The output circuit 175 is electrically connected to the DC-to-AC converter 171 while the control unit 177 is electrically connected to both of the DC-to-AC converter 171 and the output circuit 175.

In the preferred embodiment, the DC-to-AC converter 171 includes a plurality of power switches and a low-pass filter. The plurality of power switches executes high-frequency switching on a DC voltage V_{d} at an output end of a DC bus (not shown), and provides an AC voltage v_{AB} between two nodes A and B. The AC voltage v_{AB} includes many basic waves and many high frequency components. The low-pass filter filters out the high frequency components.

In practice, there are four power switches S_{A}_{⁺}, S_{A}_{^{−}}, S_{B}_{⁺} and S_{B}_{^{−}}, and the power switches S_{A}_{⁺}, S_{A}_{^{−}}, S_{B}_{⁺} and S_{B}_{^{−}} are electrically connected to one another in a full bridge manner. However, the present invention is not limited to these conditions. Those skilled in the art can change the number of the power switches and the way they are connected to one another and still achieve an AC power source.

In practice, the low-pass filter includes a filtering inductor L, and a filtering capacitor C_{f}. A first end of the filtering inductor L_{f} is electrically connected to the node A. A second end of the filtering inductor L_{f} is electrically connected to a first end of the filtering capacitor C_{f}. A second end of the filtering capacitor C_{f} is electrically connected to the node B. Thus, a second order low-pass filter is formed to provide the AC voltage v_{AB} at the basic frequency. The filtering inductor L_{f} provides an alternate output current iₒ while the filtering capacitor C_{f} provides an alternate output voltage vₒ. The number of the inductors and the number of the capacitors included in the low-pass filter of the present invention and their arrangement are not limited to those described above.

The output circuit 175 includes a grid-tie switch S_{g}. Two ends of the grid-tie switch S_{g} are electrically connected to an AC load Z_{L} and a grid 30, respectively. A first end of the AC load Z_{L} is electrically connected to the first end of the filtering capacitor C_{f}. A second end of the AC load Z_{L} is electrically connected to the second end of the filtering capacitor C_{f}. A first end of the grid 30 is electrically connected to the grid-tie switch S_{g}. A second end of the grid 30 is electrically connected to the node B. The grid-tie switch S_{g} switches the standalone and grid-tie power inverter 17 between a standalone mode and a grid-tie mode. For example, the alternate output voltage vₒ is provided to the AC load Z_{L} when the grid-tie switch S_{g} is turned off, and the alternate output current iₒ is provided to the grid 30 when the grid-tie switch S_{g} is turned on. In practice, the grid-tie switch S_{g} can be turned off to direct the alternate output current iₒ to the grid 30, and the grid-tie switch S_{g} can be turned on to direct the alternate output voltage vₒ to the AC load Z_{L}.

The control unit 177 includes a current control unit 176, a voltage control unit 178, a first switch Sⱼ and a drive circuit 179. Due to the first switch Sⱼ, the drive circuit 179 is under the control of the current control unit 176 or the voltage control unit 178 to switch the control unit 177 between a voltage control mode and a current control mode. The first switch Sⱼ can be realized by hardware or software.

Based on a current command signal iₒ* and a current feedback signal iₒ, the current control unit 176 instructs the drive circuit 179 to provide a plurality of drive signals to the DC-to-AC converter 171 to instruct the DC-to-AC converter 171 to provide the alternate output current iₒ to the grid 30 in the grid-tie mode.

In the preferred embodiment, the current command signal iₒ* is the nominal value of the alternate output current iₒ while the current feedback signal iₒ is the alternate output current. The drive signals includes a first drive signal T_{A}_{⁺}, a second drive signal T_{A}_{^{−}}, a third drive signal T_{B}_{⁺} and a fourth drive signal T_{B}_{^{−}}. As pulse width modulated signals, the drive signals A_{T}_{^{−}}, T_{A}_{^{−}}, T_{B}_{⁺} and B_{B}_{^{−}} are electrically connected to the power switches S_{A}_{⁺}, S_{A}_{^{−}}, S_{B}_{⁺} and S_{B}_{^{−}} to control the amplitude of the alternate output current iₒ.

Similarly, based on a voltage command signal vₒ* and a voltage feedback signal vₒ, the voltage control unit 178 instructs the drive circuit 179 to provide a plurality of drive signals to the DC-to-AC converter 171 to instruct the DC-to-AC converter 171 to provide the alternate output voltage vₒ to the AC load Z_{L} in the standalone mode.

In practice, the voltage command signal vₒ* is the nominal value of the alternate output voltage vₒ while the voltage feedback signal vₒ is the nominal value of the alternate output voltage. As pulse width modulated signals, the drive signals T_{A}_{⁺}, T_{A}_{^{−}}, T_{B}_{⁺} and B_{B}_{^{−}} are electrically connected to the power switches S_{A}_{⁺}, S_{A}_{^{−}}, S_{B}_{⁺} and S_{B}_{^{−}} to control the amplitude of the alternate output voltage vₒ. Moreover, based on the need for power, the drive circuit 179 provides a switch drive signal T_{g} to the grid-tie switch S_{g} to connect the alternate output current iₒ to the grid 30 or isolate the alternate output current iₒ from the grid 30 to switch the standalone and grid-tie power inverter 17 between the standalone mode or the grid-tie mode.

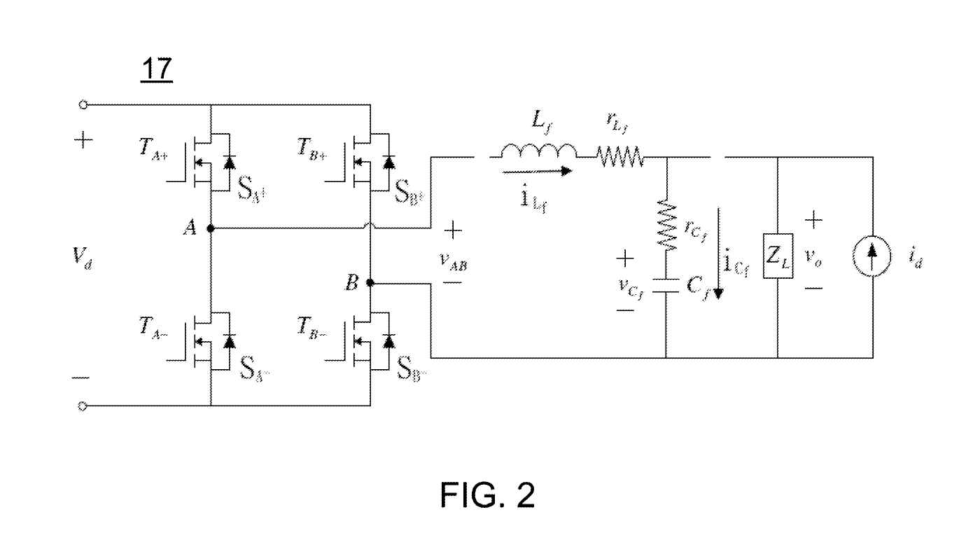

Referring to FIG. 2 that shows an equivalent circuit of the standalone and grid-tie power inverter 17 in the standalone mode, r_{L}_{_{f}} and r_{C}_{_{f}} represent equivalent internal resistances of the filtering inductor L_{f} and the filtering capacitor C_{f}, respectively. Moreover, i_{L}_{_{f}} represents the filtering inductor current that travels through the filtering inductor L_{f}. In addition, i_{C}_{_{f}} represents the filtering capacitor current that travels through the filtering capacitor C_{f}. Furthermore, v_{C}_{_{f}} represents the voltage across the filtering capacitor C_{f}. Finally, the current source i_{d} represents an interference current caused by the AC load Z_{L}.

For the convenience of analysis and simplification of the state space equations, there are several assumptions. At first, the equivalent internal resistances r_{L}_{_{f}} and r_{C}_{_{f}} of the filtering inductor L_{f} and the filtering capacitor C_{f} are small and ignored. Secondly, the power switches S_{A}_{^{−}}, S_{A}_{^{−}}, S_{B}_{⁺} and S_{B}_{^{−}} are ideal elements, and losses in the turning on and switching are zero. Thirdly, the response delays in the turning on and off of the power switches S_{A}_{⁺}, S_{A}_{^{−}}, S_{B}_{⁺} and S_{B}_{^{−}} are ignored. Fourthly, the frequencies of the switching of the power switches S_{A}, S_{A}, S_{B}_{⁺} and S_{B} are much higher than the natural frequency and modulation frequency of the system so that the control signal and input/output signal are constant in a switch cycle.

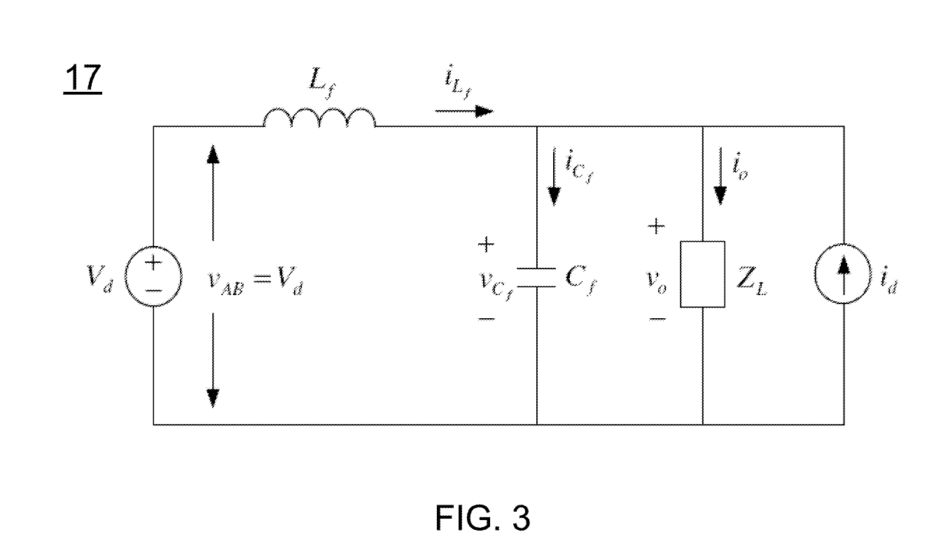

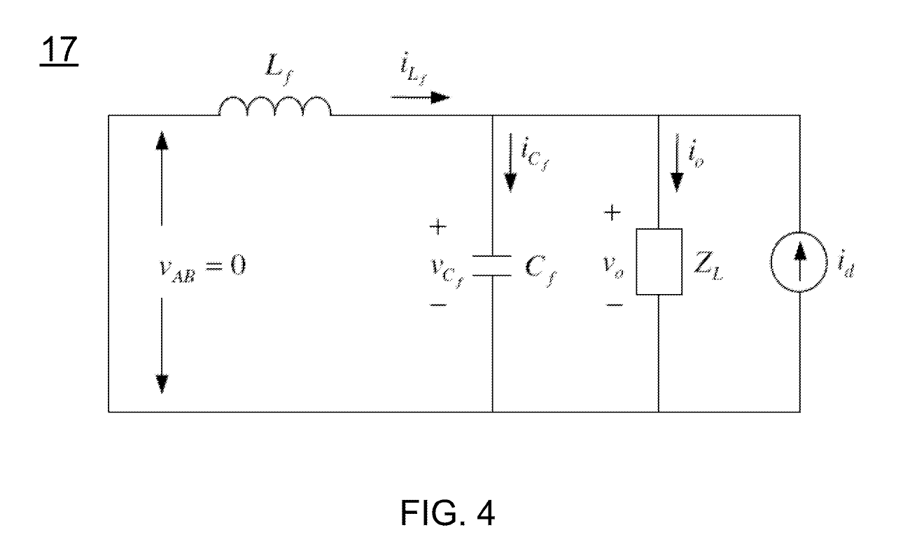

Based on the assumptions, the switching of the single pole sine pulse width modulated power switches S_{A}_{⁺}, S_{A}_{^{−}}, S_{B}_{⁺} and S_{B}_{^{−}} are divided to negative and positive semi-cycle. The negative semi-cycle is like the positive semi-cycle except the polarity of the AC voltage v_{AB}. Hence, details will be given to the positive semi-cycle only. In the standalone mode, the power switches S_{A}_{⁺}, S_{A}_{^{−}}, S_{B}_{⁺} and S_{B}_{^{−}} are switched between a first mode shown in FIG. 3 and a second mode shown in FIG. 4. In the first mode, the power switches S_{A}_{⁺} and S_{B}_{^{−}} are turned on. In the second mode, the power switches S_{A}_{⁺} and S_{B}_{⁺} are turned on or the power switches S_{A}_{^{−}} and S_{B}_{^{−}} are turned on.

In the preferred embodiment, a state space averaging method and a linearization method are executed on the positive semi-cycle to provide the positive semi-cycle with dynamic state equations (1) to (3) as follows:

$$\begin{matrix}{i}_{{L}_{f}} = \frac{1}{{L}_{f}} ( {D}_{i} {V}_{d} - {v}_{{C}_{f}} ) & ( 1 ) \\ \dot{v} = \frac{1}{{C}_{f}} ( {i}_{{L}_{f}} + {i}_{d} - {i}_{o} ) & ( 2 ) \\ {v}_{o} = {v}_{{C}_{f}} & ( 3 )\end{matrix}$$

wherein Dᵢ is the duty cycle of the on state of the power switches S_{A}_{⁺} and S_{B}_{^{−}} in every switch cycle.

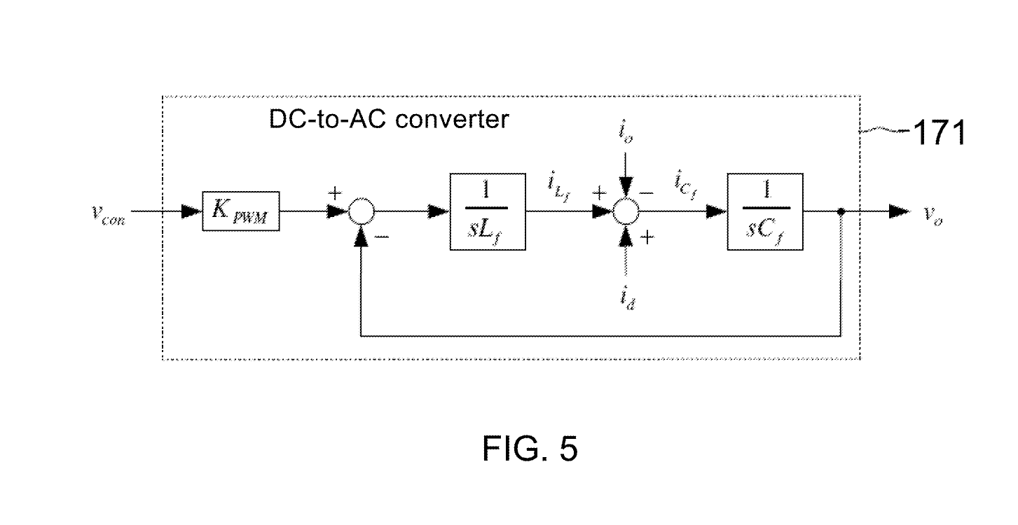

Hereinafter, the duty cycle is defined by Dᵢ=v_{con}/\hat{v}ₜᵣᵢ and a bridge power stage gain is defined by K_{PWM}=V_{d}/\hat{v}ₜᵣᵢ wherein v_{con} is a sine control signal while \hat{v}ₜᵣᵢ is the peak value of a triangle wave signal. Equations (1) to (3) can be combined with one another to provide a dynamic model of the DC-to-AC converter 171 by equation (4). By Laplace transform, the equivalent model of the DC-to-AC converter 171 can be turned to a model shown in FIG. 5.

$$\ddot{v} = - \frac{1}{{L}_{f} {C}_{f}} {v}_{o} + \frac{{K}_{PWM}}{{L}_{f} {C}_{f}} {v}_{con} - \frac{1}{{C}_{f}} {i}_{o} + \frac{1}{{C}_{f}} {i}_{d} \qquad ( 4 )$$

The alternate output voltage vₒ is chosen to be the state of the system and v_{con} is used as a control variable. Thus, equation (4) can be rewritten to be equation (5) as follows:

$$\begin{matrix}\ddot{x} = {a}_{p} x ( t ) + {b}_{p} u ( t ) + {c}_{p} z ( t ) + m ( t ) \\ = ( {a}_{pn} + Δ {a}_{pn} ) x ( t ) + ( {b}_{pn} + Δ {b}_{pn} ) u ( t ) + ( {c}_{pn} + Δ {c}_{pn} ) z ( t ) + m ( t ) \\ = {a}_{pn} x ( t ) + {b}_{pn} u ( t ) + {c}_{pn} z ( t ) + w ( t )\end{matrix} \qquad ( 5 )$$

wherein x(t)=vₒ, u(t)=v_{con}, a_{P}=−1/L_{f}C_{f}, b_{P}=K_{PWM}/L_{f}C_{f}, c_{P}=−1/C_{f}, z(t)=iₒ, m(t)=i_{d}/C_{f}, and aₚₙ, bₚₙ and cₚₙ respectively represent the parameters of the system in the normal state, and Δaₚₙ, Δbₚₙ and Δcₚₙ respectively represent the interferences of the parameters of the DC-to-AC converter 171, and w(t) represents the total uncertainty defined in equation (6) as follows:

w(t)=Δaₚₙx(t)+Δbₚₙu(t)+Δcₚₙz(t)+m(t) (6)

wherein the boundary value of the total uncertainty w(t) is defined by equation (7) wherein ρ is the boundary value of the total uncertainty and is a positive constant.

|w(t)|<ρ (7)

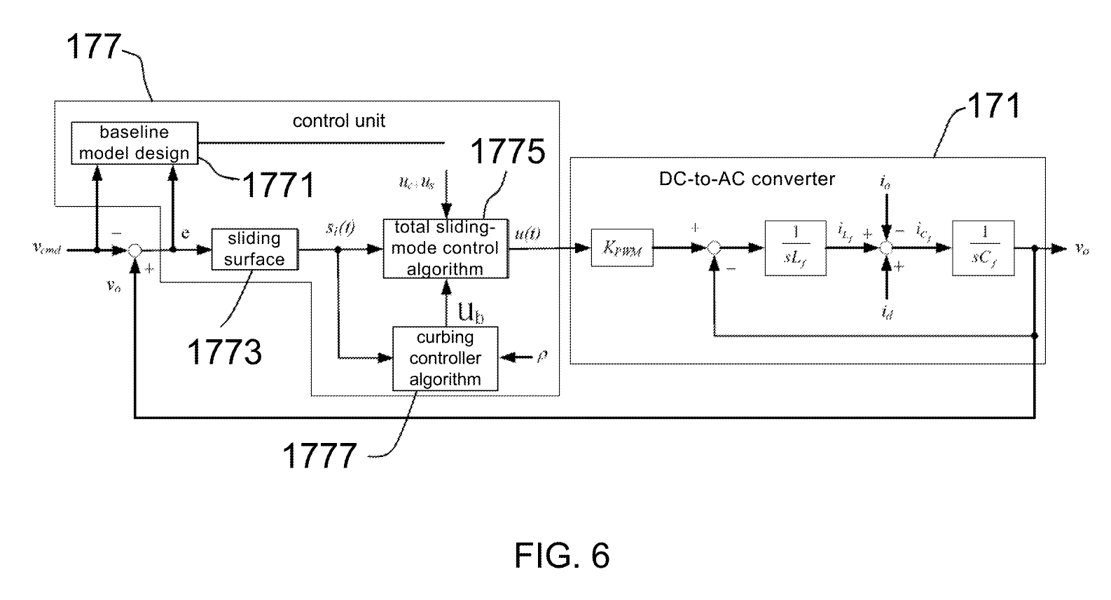

How the control unit 177 operates the plurality of power switches will be described later. Referring to FIG. 6, a controlled error is defined by e=x−x_{d}=vₒ−v_{cmd} wherein x_{d}=v_{cmd} represents the voltage command signal vₒ*. The control structure can be divided into two portions. The first portion is system performance planning. The first portion is precisely planning an expected performance of the system in the normal state. The first portion can be a baseline model design 1771. To perfectly reflect the controlled performance, the baseline model design 1771 includes computed torque controller u_{c} and a system performance planning controller uₛ. The second portion is constructing a curbing controller u_{b}. That is, the changes in the parameters of the system, the interference current i_{d} of the load and unexpected interferences of non-modeled dynamics of the system are eliminated. Therefore, the performance of the system of the baseline model design 1771 is fulfilled.

The computed torque controller u_{c} compensates for affects caused by non-linear dynamics and tries to eliminate the non-linear dynamic items from the model. With an assumption that there is not any change in the parameters of the system or any external interference, i.e., w(t)=0, equation (5) can be rewritten to be equation (8) as follows:

\ddot{x}=aₚₙx(t)+bₚₙu(t)+cₚₙz(t) (8)

Based on equation (8), the baseline model control design 1771 can be defined by equation (9) as follows:

u(t)=u_{c}+uₛ (9)

wherein u_{c} and uₛ can respectively be defined by equations (10) and (11) as follows:

u_{c}=−bₚₙ⁻¹(aₚₙx(t)+cₚₙz(t)) (10)

uₛ=bₚₙ⁻¹(\ddot{x}_{d}−k₁ė−k₂e) (11)

wherein k₁ and k₂ are positive constants. Equations (9) to (11) can be substituted in equation (8) to represent the dynamic state of the error of the system by equation (12) as follows:

ė+k₁ė+k₂e=0 (12)

If the values of k₁ and k₂ are chosen properly, the expected performance of the system such as the rise time, the largest overshoot and the stability time can easily be achieved by the second order equation. However, if there is any change in the parameters of the system or any external interference from the load, the baseline model design 1771 cannot guarantee all of the specification of the performance defined by equation (12). Moreover, the stability of the controlling system will be damaged. Hence, regardless of any uncertainty in the system, the extra curbing controller u_{b} designed in the present invention guarantees all of the specification of the performance defined by equation (12).

Equation (12) can be rewritten to represent the state of the error of the system by equations (13) and (14) as follows:

$$\begin{matrix}\frac{d}{d t} [ \begin{matrix}e \\ \dot{e}\end{matrix} ] = [ \begin{matrix}0 & 1 \\ - {k}_{2} & - {k}_{1}\end{matrix} ] [ \begin{matrix}e \\ \dot{e}\end{matrix} ] & ( 13 ) \\ \dot{e} = Ae \\ wherein e = {[ \begin{matrix}e & \dot{e}\end{matrix} ]}^{T} A = [ \begin{matrix}0 & 1 \\ - {k}_{2} & - {k}_{1}\end{matrix} ] . & ( 14 )\end{matrix}$$

Furthermore, a smooth sliding surface function sₗ(t) is defined by equation (15) as follows:

$${s}_{l} ( t ) = c ( e ) - c ( {e}_{0} ) - {\int }_{0}^{t} \frac{\partial c}{\partial {e}^{T}} Ae d τ \qquad ( 15 )$$

wherein c(e) represents an pointer function and is designed by ∂c/∂e^{T}=[0 bₚₙ⁻¹], e₀ is the initial value of e(t). sₗ(t) is zero when the time is zero and is always zero when the time is larger than zero as defined by equation [symbol] (16) as follows:

$${\dot{s}}_{l} ( t ) = \frac{\partial c}{\partial {e}^{T}} \dot{e} - \frac{\partial c}{\partial {e}^{T}} Ae = 0 \qquad ( 16 )$$

It should be noted that sₗ(t) is zero when the time is zero. That is, the state of the system has been on the sliding surface 1773 from the beginning, without the reaching phase as would be in the conventional sliding-mode control.

In consideration of the unknown changes in the parameters of the system and external interferences, equation (5) can be rewritten to be equation (17) as follows:

bₚₙ⁻¹\ddot{x}(t)−bₚₙ⁻¹aₚₙx(t)−bₚₙ⁻¹cₚₙz(t)=u(t)+bₚₙ⁻¹w(t) (17)

Obviously, the control input designed by equation (9) does not ensure that equation (17) satisfies the baseline model design 1771. Hence, there is a need for an extra controller to render the closed-loop dynamics of the controlling system (the standalone and grid-tie power inverter 17) like the baseline model design 1771.

A total sliding-mode control algorithm 1775 can be defined by equation (18) as follows:

u=u_{c}+uₛ+u_{b} (18)

wherein u_{c} and uₛ are defined by equations (10) and (11), respectively, and the curbing controller u_{b} is defined by equation (19) as follows:

u_{b}=−ρbₚₙ⁻¹sgn(sₗ(t)) (19)

In the foregoing equation, sgn(·) is a sign function. The third controller u_{b} is so designed for two purposes. At first, the dynamics of the system is retained on the sliding surface 1773. That is, sₗ(t) is zero so that u_{b} is called the “curbing controller.” Secondly, the closed-loop dynamics of the system is like the baseline model design 1771.

Equations (10), (11) and (18) are substituted in equation (17) to represent the dynamic equation of the error by equation (20) as follows:

ė=Ae+bₘ[u_{b}+bₚₙ⁻¹w(t)] (20)

wherein bₘ=[0 bₚₙ]^{T}. Moreover, sₗ(t) is zero when the time is zero. To retain the state of the system on the sliding surface 1773, a sliding condition is defined by equation (21) as follows:

sₗ(t)≠0, sₗ(t)\dot{s}ₗ(t)<0 (21)

Equation (15) is differentiated versus the time and the dynamic equation of the error, equation (20), is used so that \dot{s}ₗ(t) can be defined by equation (22) as follows:

$$\begin{matrix}{\dot{s}}_{l} ( t ) = \frac{\partial c}{\partial e} \dot{e} - \frac{\partial c}{\partial e} Ae \\ = \frac{\partial c}{\partial e} \{ Ae + {b}_{m} [ {u}_{b} + {b}_{pn}^{- 1} w ( t ) ] - A \\ = {u}_{b} + {b}_{pn}^{- 1} w ( t )\end{matrix} \qquad ( 22 )$$

Equation (22) is multiplied by sₗ(t), and equation (19) is substituted in equation (22) to provide equation (23) as follows:

$$\begin{matrix}{s}_{l} ( t ) {\dot{s}}_{l} ( t ) = {s}_{l} ( t ) [ {u}_{b} + {b}_{pn}^{- 1} w ( t ) ] \leq \\ {s}_{l} ( t ) {u}_{b} + {b}_{pn}^{- 1} \vert {s}_{l} ( t ) ‖ w ( t ) \\ = - ρ {b}_{pn}^{- 1} \vert {s}_{l} ( t ) \vert + {b}_{pn}^{- 1} \vert {s}_{l} ( t ) \vert \vert w ( t ) \vert < 0\end{matrix} \qquad ( 23 )$$

Based on equation (23) and |w(t)|<ρ, the satisfaction of the controlling conditions of the sliding-mode is guaranteed in the entire control cycle. However, it is another difficult issue to choose the boundary value of the total uncertainty w(t). If a large boundary value is chosen, the sign function of the curbing controller u_{b} will results in serious control vibration that could easily wear out the switches and excite un-stability of the system. On the other hand, if a small boundary value is chosen, the controlled system would be unstable.

The primary advantage of the sliding-model control is insensitivity to the changes in the parameters of the system and the interferences from the external load on the switch curved surface so that its trajectory can be retained on the switch curved surface by properly choosing the control gain ρ. In practice, it is however difficult to measure the changes in the parameters of the system and know the interferences from the external load. Hence, in the conventional sliding-mode control algorithm, a large control gain ρ is chosen. Although it is simple to execute a constant control gain, the switch curved surface could easily entails an undesired shift that incurs the control vibration.

Hence, an adaptive algorithm is used in the total sliding-mode control system of the present invention to adjust the boundary value of the total uncertainty w(t), thus developing an adaptive total sliding-mode control system.

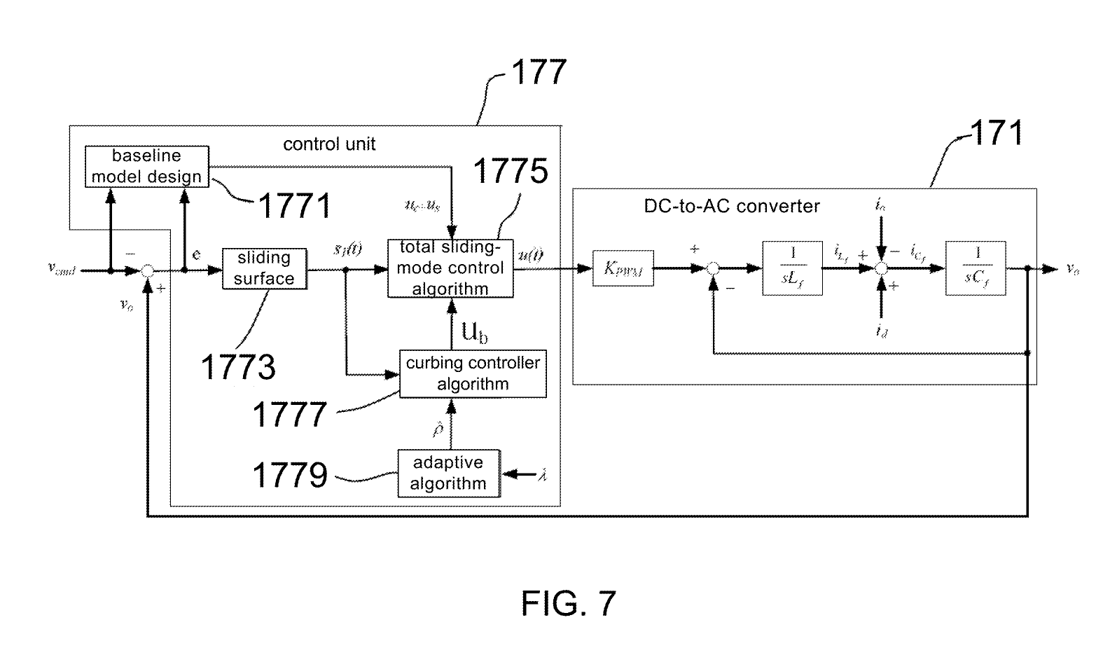

Referring to FIG. 7, an adaptive algorithm 1779 is used to estimate the boundary value of the total uncertainty w(t) defined by equation (24) as follows:

$${ρ}^{\dot{\hat{}}} ( t ) = \frac{1}{λ} {b}_{pn}^{- 1} \vert {s}_{l} ( t ) \vert \qquad ( 24 )$$

wherein \hat{ρ} is the estimated value of, ρ, and λ>0 is an adaptive gain parameter. In equation, ρ is substituted for \hat{ρ} so that the curbing controller u_{b} can be rewritten to be equation (25) as follows:

u_{b}=−\hat{ρ}(t)bₚₙ⁻¹sgn(sₗ(t)) (25)

A Lyapunov function is chosen as follows:

$${V}_{l} ( {s}_{l} ( t ) , \tilde{ρ} ( t ) ) = \frac{1}{2} [ {s}_{l}^{2} ( t ) + λ {\tilde{p}}^{2} ( t ) ] \qquad ( 26 )$$

wherein \tilde{ρ}(t)=\hat{ρ}(t)−ρ is defined to be the estimated error. The Lyapunov function is differentiated versus the time to provide equation (27) as follows:

\dot{V}ₗ(sₗ(t), \tilde{ρ}(t))=sₗ(t)\dot{s}ₗ(t)+λ\tilde{ρ}(t){tilde over (\dot{ρ}(t) (27)

Equations (22), (24) and (25) are substituted in equation (27) to provide equation (28) as follows

$$\begin{matrix}{\dot{V}}_{l} ( {s}_{l} ( t ) , \tilde{ρ} ( t ) ) = {s}_{l} ( t ) [ {u}_{b} + {b}_{pn}^{- 1} w ( t ) ] + λ ( \hat{ρ} ( t ) - ρ ) {ρ}^{\dot{\hat{}}} ( t ) \\ = {s}_{l} ( t ) [ - \hat{ρ} ( t ) {b}_{pn}^{- 1} sgn ( {s}_{l} ( t ) ) + {b}_{pn}^{- 1} w ( t ) ] + \\ λ ( \hat{ρ} ( t ) - ρ ) \frac{1}{λ} {b}_{pn}^{- 1} \vert {s}_{l} ( t ) \vert \\ = {b}_{pn}^{- 1} {s}_{l} ( t ) w ( t ) - ρ {b}_{pn}^{- 1} \vert {s}_{l} ( t ) \vert \leq \\ - {b}_{pn}^{- 1} \vert {s}_{l} ( t ) \vert [ ρ - w ( t ) ] \leq 0\end{matrix} \qquad ( 28 )$$

\dot{V}ₗ(sₗ(t),\tilde{ρ}(t)) is the negative semi-function since \dot{V}ₗ(sₗ(t),\tilde{ρ}(t))≦0. That is, Vₗ(sₗ(t),\tilde{ρ}(t))≦V(sₗ(0),\tilde{ρ}(0)). Accordingly, both of sₗ(t) and \tilde{ρ}(t) are bounded functions. It is defined that Q(t)≡bₚₙ⁻¹|sₗ(t)|(ρ−w(t))≦−Vₗ(sₗ(t),\tilde{ρ}(t)), and Q(t) is differentiated versus the time to provide equation (29) as follows:

∫₀^{t}Q(τ)dτ≦Vₗ(sₗ(0),\tilde{ρ}(0))−Vₗ(sₗ(t),\tilde{ρ}(t)) (29)

Because Vₗ(sₗ(0),\tilde{ρ}(0)) is a bounded functional and Vₗ(sₗ(t),\tilde{ρ}(t)) is a non-increasing bounded function, there is provided equation (30) as follows:

$${lim}_{t -> ∞} {\int }_{0}^{t} Q ( t ) d τ < ∞ \qquad ( 30 )$$

Similarly, \dot{Q}(t) is a bounded function. Based on Barbalet's lemma, it can be inferred that

$${lim}_{t -> ∞} Q ( t ) = 0.$$

That is, sₗ(t) approaches zero when the time approaches the infinity. Hence, the adaptive total sliding-mode control system exhibits a characteristic that it gets more and more stable.

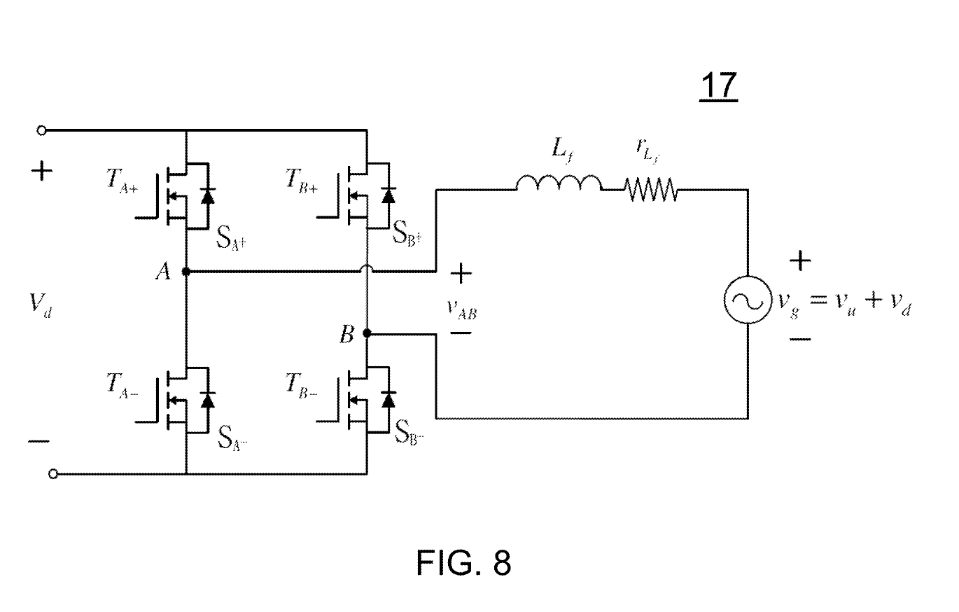

Referring to FIG. 8, the standalone and grid-tie power inverter 17 is in the grid-tie mode. The equivalent circuit shown in FIG. 8 is like the one shown in FIG. 2 except that v_{g} at the output end is the voltage of the grid 30 and v_{g}=vᵤ+v_{d} wherein vᵤ is the voltage of the grid 30, and v_{d} is the external interference voltage.

For the convenience of analysis and simplification of the state space equations, there are several assumptions. At first, the equivalent internal resistance r_{L}_{_{f}} of the filtering inductor L_{f} is small and ignored. Secondly, (2) the power switches S_{A}, S_{A}, S_{B}_{⁺} and S_{B} are ideal elements, and losses in the turning on and switching are zero. Thirdly, the response delay in the turning on and off of the power switches S_{A}_{⁺}, S_{A}_{^{−}}, S_{B}_{⁺} and S_{B}_{^{−}} are ignored. Fourthly, the frequencies of the switching of the power switches S_{A}_{⁺}, S_{A}_{^{−}}, S_{B}_{⁺} and S_{B}_{^{−}} are much higher than the natural frequency and modulation frequency of the system so that the control signal and input/output signal are constant in a switch cycle.

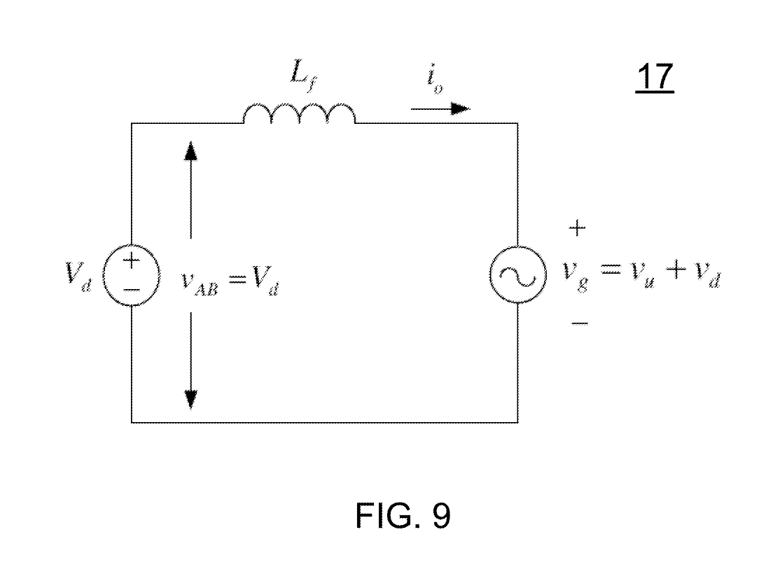

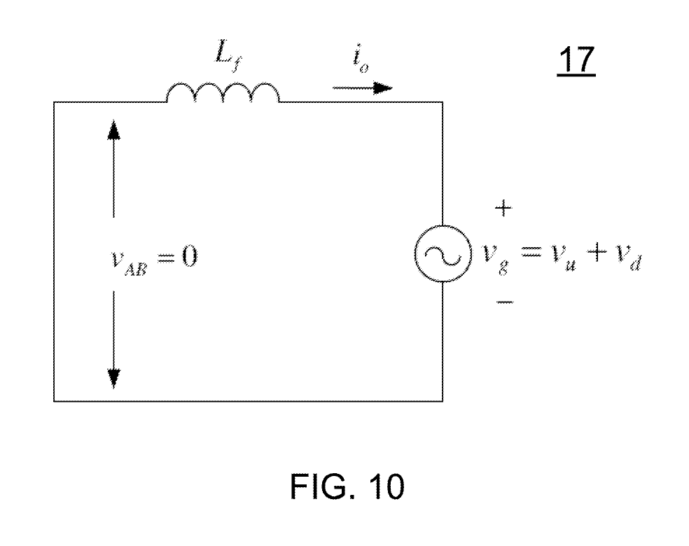

Based on the assumptions, the switching of the single pole sine pulse width modulated power switches S_{A}_{⁺}, S_{A}_{^{−}}, S_{B}_{⁺} and S_{B}_{^{−}} are divided to negative and positive semi-cycle. The negative semi-cycle is like the positive semi-cycle except the polarity of the AC voltage v_{AB}. Hence, details will be given to the positive semi-cycle only. In the grid-tie mode, the power switches S_{A}_{⁺}, S_{A}_{^{−}}, S_{B}_{⁺} and S_{B}_{^{−}} are switched between a first mode shown in FIG. 9 and a second mode shown in FIG. 10. In the first mode, the power switches S_{A}_{⁺} and S_{B}_{^{−}} are turned on. In the second mode, the power switches S_{A}_{⁺} and S_{B}_{⁺} are turned on or the power switches S_{A} and S_{B} are turned on.

In the preferred embodiment, a state space averaging method and a linearization method are executed on the positive semi-cycle to provide the positive semi-cycle with dynamic state equation (31) as follows:

$${\dot{i}}_{o} = \frac{1}{{L}_{f}} ( {V}_{d} {D}_{i} - {v}_{u} - {v}_{d} ) \qquad ( 31 )$$

wherein iₒ is an alternate output current, and Dᵢ is the duty cycle of the on state of the power switches S_{A}_{⁺} and S_{B}_{^{−}} in every switch cycle.

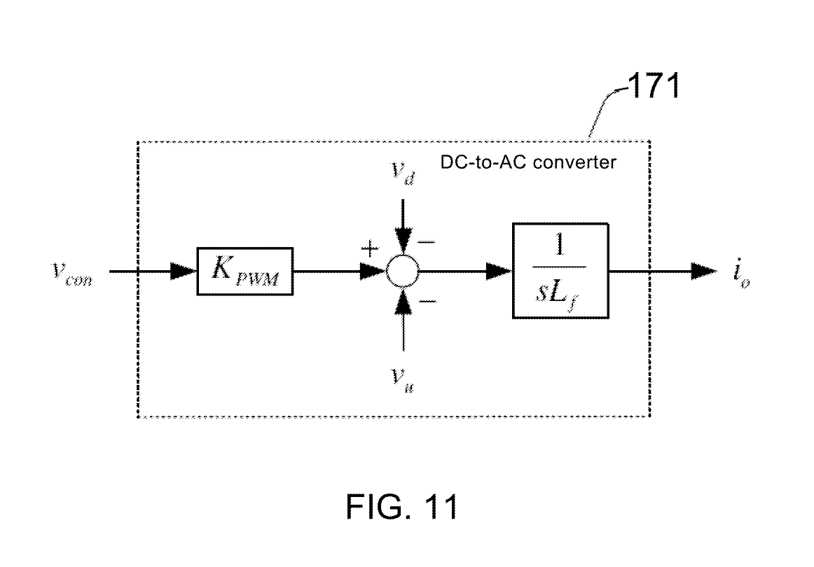

Hereinafter, the duty cycle is defined by Dᵢ=v_{con}/\hat{v}ₜᵣᵢ and a bridge power stage gain is defined by K_{PWM}=V_{d}/\hat{v}ₜᵣᵢ wherein v_{con} is a sine control signal while \hat{v}ₜᵣᵢ is the peak value of a triangle wave signal. The dynamic model of the standalone and grid-tie power inverter 17 can be defined by equation (32). By Laplace transform, the equivalent model of the DC-to-AC converter 171 can be turned to a model shown in FIG. 11.

$${\dot{i}}_{o} = \frac{{K}_{PWM}}{{L}_{f}} {v}_{con} - \frac{1}{{L}_{f}} {v}_{u} - \frac{1}{{L}_{f}} {v}_{d} \qquad ( 32 )$$

The alternate output current iₒ is chosen to be the state of the system and v_{con} is used as a control variable. Thus, equation (32) can be rewritten to be equation (33) as follows:

$$\begin{matrix}{\dot{x}}_{g} ( t ) = {d}_{p} u ( t ) + {e}_{p} f ( t ) + g ( t ) \\ = ( {d}_{pn} + Δ {d}_{pn} ) u ( t ) + ( {e}_{pn} + Δ {e}_{pn} ) f ( t ) + g ( \\ = {d}_{pn} u ( t ) + {e}_{pn} f ( t ) + h ( t )\end{matrix} \qquad ( 33 )$$

wherein x_{g}(t)=iₒ, u(t)=v_{con}, dₚ=K_{PWM}/L_{f}, eₚ=−1//L_{f}, f(t)=vᵤ, g(t)=−v_{d}/L_{f}, and dₚₙ [symbol] eₚₙ are respectively the parameters dₚ [symbol] eₚ of the system in the normal state, and Δdₚₙ [symbol] Δeₚₙ respectively represent the interferences of the parameters of the system, and h(t) represents the total uncertainty defined in equation (34) as follows:

h(t)=Δdₚₙu(t)+Δeₚₙf(t)+g(t) (34)

wherein the boundary value of the total uncertainty h(t) is defined by equation (35) wherein ρ_{g} is the boundary value of the total uncertainty and is a positive constant.

|h(t)|<ρ_{g} (35)

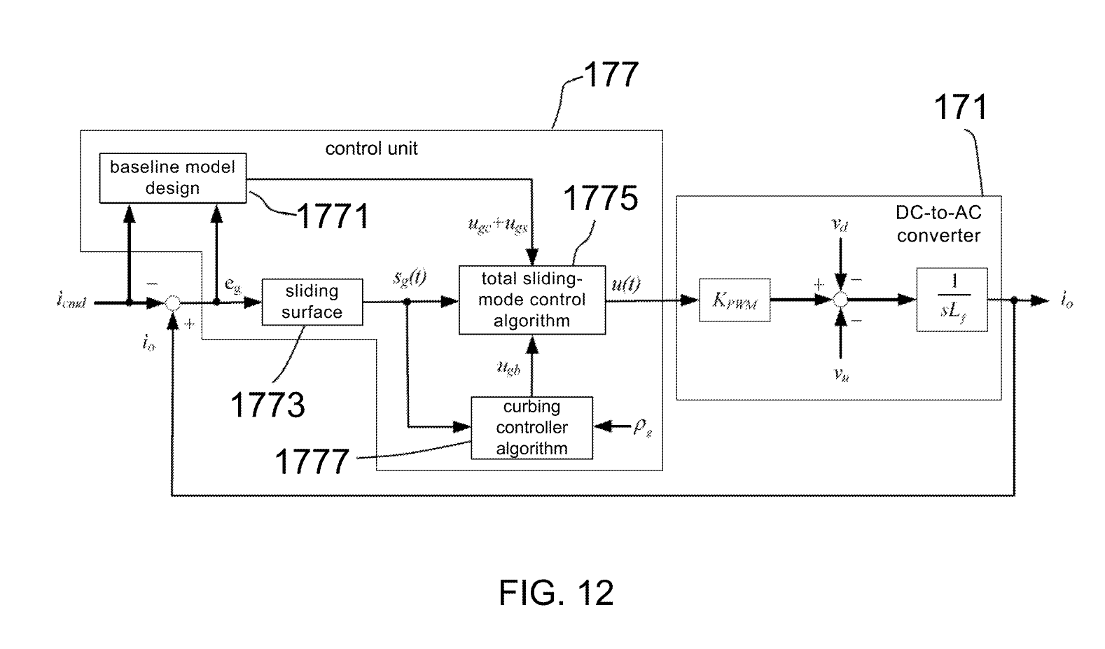

How the control unit 177 operates the plurality of power switches will be described later. Referring to FIG. 12, a controlled error is defined by e_{g}=x_{g}−x_{gd}=iₒ−i_{cmd} wherein x_{gd}=i_{cmd} represents the current command signal iₒ*. With an assumption that there is not any change in the parameters of the system or any external interference, equation (33) can be rewritten to represent a model of the system in the normal state as defined by equation (36) as follows:

\dot{x}_{g}(t)=dₚₙu(t)+eₚₙf(t) (36)

According to equation (36), the baseline model design 1771 can be defined by equation (37) as follows:

u=u_{gc}+u_{gs} (37)

wherein u_{gc} and u_{gs} can respectively be defined by equations (38) and (39) as follows:

u_{gc}=−dₚₙ⁻¹eₚₙf (38)

u_{gs}=dₚₙ⁻¹(\dot{x}_{gd}−k₃e_{g}) (39)

wherein k₃ is a positive constant. Equations (37) to (39) are substituted in equation (36) to define the dynamics of the error of the system by equation (40) as follows:

ė_{g}+k₃e_{g}=0 (40)

If the value of k₃ is chosen properly, the expected performance of the system can easily be achieved by the first order equation. However, if there is any change in the parameters of the system or any external interference from the load, the baseline model design 1771 cannot guarantee all of the specification of the performance defined by equation (40). Moreover, the stability of the controlling system will be damaged. Hence, regardless of any uncertainty in the system, the extra curbing controller u_{gh} designed in the present invention guarantees all of the specification of the performance defined by equation (40) and defines the sliding surface as follows:

$${s}_{g} ( t ) = {e}_{g} ( t ) - {e}_{g} ( 0 ) + {k}_{3} {\int }_{0}^{t} {e}_{g} ( τ ) d τ \qquad ( 41 )$$

wherein e_{g}(0) is the initial value of e_{g}(t). s_{g}(t) is zero when the time is zero. Based on equation (41), the slope of the function can be defined by equation (42) as follows:

\dot{s}_{g}(t)=ė_{g}(t)+k₃e_{g}(t)=0 (42)

Based on equation (42), s_{g}(t) is always when the time is larger than zero. That s_{g}(t) is zero when the time is zero means that the state of the system has been on the sliding surface 1773 since the beginning, without any reaching phase as would be in the conventional sliding-mode control.

In consideration of unknown changes in the parameters of the system and the external voltage interferences, equation (33) can be rewritten to be equation (43) as follows:

dₚₙ⁻¹\dot{x}_{g}(t)−dₚₙ⁻¹eₚₙf(t)=u(t)+dₚₙ⁻¹h(t) (43)

Obviously, the controlled error designed by equation (37) does not guarantee that equation (43) satisfies the baseline model design 1771. Hence, there is a need for an extra controller to render the closed-loop dynamic performance of the system like the baseline model design 1771. The total sliding-mode control algorithm 1775 is defined by equation (44) as follows:

u=u_{gc}+u_{gs}+u_{gb} (44)

where u_{gc} and u_{gs} are respectively defined by equations (38) and (39), and the curbing controller u_{gb} is defined by equation (45) as follows:

u_{gb}=−ρ_{g}dₚₙ⁻¹sgn(s_{g}(t)) (45)

The third controller u_{gb} is so designed for two purposes. At first, the dynamics of the system is retained on the sliding surface 1773. That is, s_{g}(t) is zero so that u_{gb} is called the “curbing controller.” Secondly, the closed-loop dynamics of the system is like the performance of the baseline model design 1771.

Equations (38), (39) and (44) can be substituted in equation (43), and the dynamic equation of the error can be defined by equation (46) as follows:

ė_{g}(t)==k₃e_{g}(t)+dₚₙ[u_{gb}+dₚₙ⁻¹h(t)] (46)

s_{g}(t) is zero when the time is zero. To retain the state of the system on the sliding surface 1773 at any point of time, a sliding condition is defined by equation (47) as follows:

s_{g}(t)≠0, s_{g}(t)\dot{s}_{g}(t)<0 (47)

wherein after equation (41) is differentiated versus the time and multiplied by s_{g}(t), equation (45) can be substituted in equation (46) to provide equation (48) as follows:

$$\begin{matrix}{s}_{g} ( t ) {\dot{s}}_{g} ( t ) = {s}_{g} ( t ) {d}_{pn} [ {u}_{gb} + {d}_{pn}^{- 1} h ( t ) ] \leq \\ {s}_{g} ( t ) {d}_{pn} {u}_{gb} + \vert {s}_{g} ( t ) \vert \vert h ( \\ = - {ρ}_{g} \vert {s}_{g} ( t ) \vert + \vert {s}_{g} ( t ) \vert h ( t ) \vert < 0\end{matrix} \qquad ( 48 )$$

Based on equation (48) and |h(t)|<ρ_{g}, the satisfaction of the sliding condition is guaranteed in the entire control cycle.

According to the present invention, an adaptive algorithm is further used in the total sliding-mode control system to spontaneously adjust the boundary value of the total uncertainty h(t), thus developing an adaptive total sliding-mode control system.

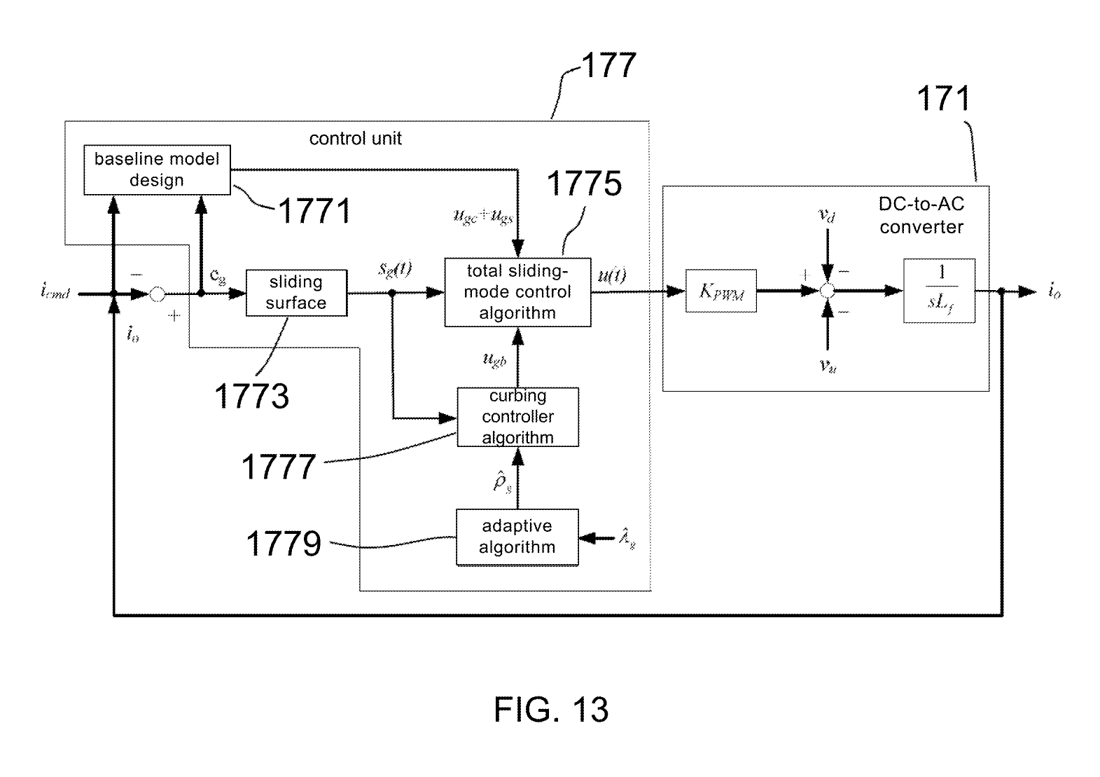

Referring to FIG. 13, an adaptive algorithm 1779 is used to estimate the boundary value of the total uncertainty h(t) by equation (49) as follows:

$${{ρ}^{\dot{\hat{}}}}_{g} ( t ) = \frac{1}{{λ}_{g}} \vert {s}_{g} ( t ) \vert \qquad ( 49 )$$

wherein \hat{ρ}_{g} is the estimated value of ρ_{g}, and λ_{g}>0 is an adaptive gain parameter. In equation (45), \hat{ρ}_{g} is substituted for ρ_{g} so that the curbing controller can be rewritten to be equation (50) as follows:

u_{gb}=−\hat{ρ}_{g}(t)dₚₙ⁻¹sgn(s_{g}(t)) (50)

From the proof of the stability by the Lyapunov function and Barbalet's lemma, it can be learnt that s_{g}(t) approaches zero when the time approaches the infinity. Hence, the adaptive total sliding-mode control system exhibits a characteristic that it gets more and more stable. The proof of the stability in the grid-tie mode is like in the standalone mode and hence will not be described in detail.

As discussed above, the grid-tie switch connects the AC power output to the grid or isolates the AC power output from the grid to switch the standalone and grid-tie power inverter between the standalone mode and the grid-tie mode, and the adaptive total sliding-mode control of the control unit guarantees the stable closed-loop control.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A standalone and grid-tie power inverter including:
a DC-to-AC converter 171 for converting a DC power source into an AC power output;
an output circuit 175 electrically connected to the DC-to-AC converter 171, wherein the output circuit 175 includes a grid-tie switch for connecting the AC power output to a grid 30 or isolating the AC power output from the grid 30; and
a control unit 177 electrically connected to the DC-to-AC converter 171 and the output circuit 175, wherein the control unit 177 instructs the DC-to-AC converter 171 to provide the AC power output based on a command signal and a feedback signal from the DC-to-AC converter 171, wherein the control unit 177 controls the grid-tie switch to switch the standalone and grid-tie power inverter between a standalone mode and a grid-tie mode.

2. The standalone and grid-tie power inverter according to claim 1, wherein the DC-to-AC converter 171 includes:
a plurality of power switches electrically connected to one another in a full bridge manner; and
a low-pass filter electrically connected to the power switches and the output circuit.

3. The standalone and grid-tie power inverter according to claim 2, wherein the AC power output includes an alternate output voltage and an alternate output current, wherein the alternate output voltage is provided to an AC load when the grid-tie switch is turned off, wherein the alternate output voltage is provided to the grid when the grid-tie switch is turned on.

4. The standalone and grid-tie power inverter according to claim 3, wherein the command signal is a current command signal or a voltage command signal, wherein the feedback signal is a current feedback signal or a voltage feedback signal, wherein the current feedback signal is the alternate output current, wherein the voltage feedback signal is the alternate output voltage.

5. The standalone and grid-tie power inverter according to claim 4, wherein the control unit includes a current controller, a voltage controller, a first switch realized by hardware or software, and a drive circuit electrically connected to the current controller or the voltage controller through the switching by the first switch.

6. The standalone and grid-tie power inverter according to claim 5, wherein based on the current command signal and the current feedback signal, the current controller controls the drive circuit to provide a plurality of drive signals to the power switches, and controls duty cycles of the power switches to instruct the DC-to-AC converter to connect the alternate output current to the grid or isolate the alternate output current from the grid.

7. The standalone and grid-tie power inverter according to claim 5, wherein based on the voltage command signal and the voltage feedback signal, the current controller controls the drive circuit to provide a plurality of drive signals to the power switches, and controls duty cycles of the power switches to instruct the DC-to-AC converter to connect the alternate output voltage to the grid or isolate the alternate output voltage from the grid.

8. The standalone and grid-tie power inverter according to claim 1, wherein the control unit adopts an adaptive total sliding-mode control method to control duty cycles of the power switches to instruct the AC power output to follow command signal, wherein the adaptive total sliding-mode control method includes:
a system performance-planning algorithm for planning the performance of the DC-to-AC converter in a normal situation;
a curbing controller algorithm for eliminating changes in parameters of the DC-to-AC converter and external load interferences to retain the operation of the DC-to-AC converter on a sliding surface; and
an adaptive algorithm for estimating a boundary value of a total uncertainty to spontaneously adjust the boundary value of the total uncertainty.

9. The standalone and grid-tie power inverter according to claim 8, wherein the total sliding-mode control method proves stability of the DC-to-AC converter through a Lyapunov function and Barbalet's lemma.
